(19) United States
(12) Patent Application Publication
(10) Pub. No.: US 2019/0186433 A1
(43) Pub. Date: Jun. 20, 2019

(54) EXHAUST GAS COOLER AND EXHAUST GAS RECIRCULATION SYSTEM WITH AN EXHAUST GAS COOLER

(71) Applicant: Hanon Systems, Daejeon (KR)

(72) Inventors: Guillaume Hebert, Stare Mesto (CZ); Andrej Repa, Dolna Suca (SK)

(21) Appl. No.: 16/217,230

(22) Filed: Dec. 12, 2018

(30) Foreign Application Priority Data
Dec. 14, 2017 (DE) 102017222740.0

(51) Int. Cl. F02M 26/32

(52) U.S. Cl. CPC F02M 26/32

(57) ABSTRACT

An exhaust gas cooler (10) comprises at least one exhaust gas channel (16) defined by at least one wall that, at the inlet (12), comprises at least one edge substantially perpendicular to the direction of flow, and is distinguished thereby that at least one edge is covered by a cap (22) defining an air gap toward the edge.

An exhaust gas recirculation system comprises at least one such exhaust gas cooler.

### FIELD OF TECHNOLOGY

The invention relates to an exhaust gas cooler as well as an exhaust gas recirculation system with at least one such exhaust gas cooler.

It is customary in the field of internal combustion engines to recirculate exhaust gas to a certain extent to the fresh air side in order to lower the fuel combustion and decrease emissions. At least under certain operational states the recirculated exhaust gas must be cooled.

### PRIOR ART

For example U.S. Pat. No. 8,002,022 B2 discloses in this regard to conduct the exhaust gas through numerous exhaust gas channels whose front edges are soldered to base plates and which are received in a housing such that between the housing and the exhaust gas tubes, or between the exhaust gas tubes, a flow can be generated comprised for example of liquid coolant, in particular of water/glycol. However, herein the cooler is heated, especially on the gas inlet side, which leads to the cooler having at this site a markedly higher temperature than in the other portions of the structure. This results in an inhomogeneous temperature distribution in the material of the cooler and therewith to stresses. Especially temperature changes of the gas as well as also of the coolant that occur due to the nonsteady operational behaviour of the internal combustion engine (for example cold start, load change, exhaust gas recirculation (EGR) rate, etc.) at different material thicknesses, and therewith different temperature change rates, lead to further inhomogeneities in the temperature distribution which lead to the described stresses.

In the proximity of the gas inlet such inhomogeneities assume an especially critical form since the thin front edges of the exhaust gas tubes combine with the non-cooled hot exhaust gas mass flow and, due to the thinness of the walls, the introduced heat can only be slowly transferred to the cooling water. For another, the exhaust gas tubes are here customarily laterally connected to a housing with a markedly higher wall thickness and whose temperature therefore changes with greater thermal inertia, or the housing walls are not directly exposed to the hot exhaust gas mass flow. In some applications there is outside the housing a thickly walled flange which further exacerbates the situation. The heated exhaust gas tubes in the inlet region expand since the temperature of the housing and/or of the flange has not yet changed sufficiently to produce a similar expansion, and these different degrees of expansions lead to stresses.

The stresses lead to plastic deformation in the thinner structure, the front edges of the exhaust gas tubes, which are resiliently compressed and/or buckle. During the cooling either the comparatively thin sheet metal cools faster or all of the listed components are in fact cooling simultaneously; however the compressed sheet metal must return to its initial position and expand; however, this generates tensile stresses in the front edge of the exhaust gas tube. This alternating loading and plastic deformation leads to failure of the material of the exhaust gas tube. In this regard it must also be considered that an exhaust gas cooler must undergo the described alternating loading several hundred thousand times over its service life.

The above described increased heat introduction in the inlet region can, moreover, lead to the boiling of the coolant in this region.

### DESCRIPTION OF THE INVENTION

Against this background, the invention addresses the problem of specifying a permanently stable and simultaneously cost-effective exhaust gas cooler.

This problem is resolved through the exhaust gas cooler described in patent claim 1.

According to this description at least one edge of at least one wall of at least one exhaust gas tube is capped at the inlet by a cap such that an air gap is defined toward the edge. The air gap can be implemented to be extremely minimal and does not necessarily need to extend over the entire width and/or height of the described edge, when the exhaust gas cooler is considered in the direction of flow. Rather, the critical issue is that the edge, due to the cap according to the invention, is not exposed to the hot exhaust gas over its entire extent, which would lead to the above described problems. The cap can also be denoted a covering or deflection device. It should be stated that in the following the exhaust gas channel is also referred to as exhaust gas tube.

Through the covering of the edge, the edge is heated to a lesser degree and the described problems can be avoided. Stated differently, the edge does not expand as much as it would without the cap according to the invention, and the coolant is also not heated as much. Consequently, overall the service life of such exhaust gas cooler can be increased.

The invention consequently combines the advantages of an exhaust gas cooler that can be circumferentially provided with ribs or fins, namely the advantages of high heat transfer rate and low pressure loss, through the protection of the edges of the exhaust gas tube at the exhaust gas inlet.

Preferred further developments of the exhaust gas cooler according to the invention are described in the further claims.

In order to be able to utilize the advantages to their greatest maximum extent, at least one cap is provided which has at least in one direction perpendicular to the direction of flow a maximal extent that corresponds to a width of the wall of the exhaust gas tube and/or a distance between two exhaust gas tubes, customarily measured in the vertical direction. When both directions of extent are implemented as described, the edge is completely covered; however, it should be stated that discrete regions of the edge, in particular in the direction of width, can be left bare.

As to the mounting of the cap according to the invention, it has been found to be advantageous if it is pluggable onto adjacent walls of two exhaust gas channels.

In order to be able to keep the pressure loss advantageously low, it is preferred for the end, directed toward the flow, of the at least one cap to be rounded.

For the same reason at least one cap includes in its course in the direction of flow at least one obliquity and/or one stage.

Although any desired suitable material can be employed for the cap, it is currently preferred to implement at least one cap of a metal. The metal preferably involves steel, in particular as the material a comparatively thin sheet steel is satisfactory.

For the securement on preferably two adjacent walls of exhaust gas channels it is preferred for at least one cap to comprise at least one fastening tab.

An especially secure attachment is attained thereby that at least one cap is soldered or welded onto typically two adjacent walls of exhaust gas channels.

It should be stated that the invention described here can be combined with all features and aspects that are described in the German Patent Application filed 22 Sep. 2017 with the file number 1020017216819.6 with the Title “Exhaust Gas Cooler and Exhaust Gas Recirculation System” by the Applicant. Combinations of all characteristics described in said application and in the present application are consequently to be considered as embodiments of the invention.

### BRIEF DESCRIPTION OF THE DRAWING

In the following an embodiment of the invention depicted in the Figures will be described in further detail with reference thereto. In the drawing show:

FIG. 1 a perspective partial view of an exhaust gas cooler according to the invention, and

FIG. 2 a sectional view of the inlet region of the exhaust gas cooler according to the invention.

### DETAILED DESCRIPTION OF A PREFERRED EMBODIMENT OF THE INVENTION

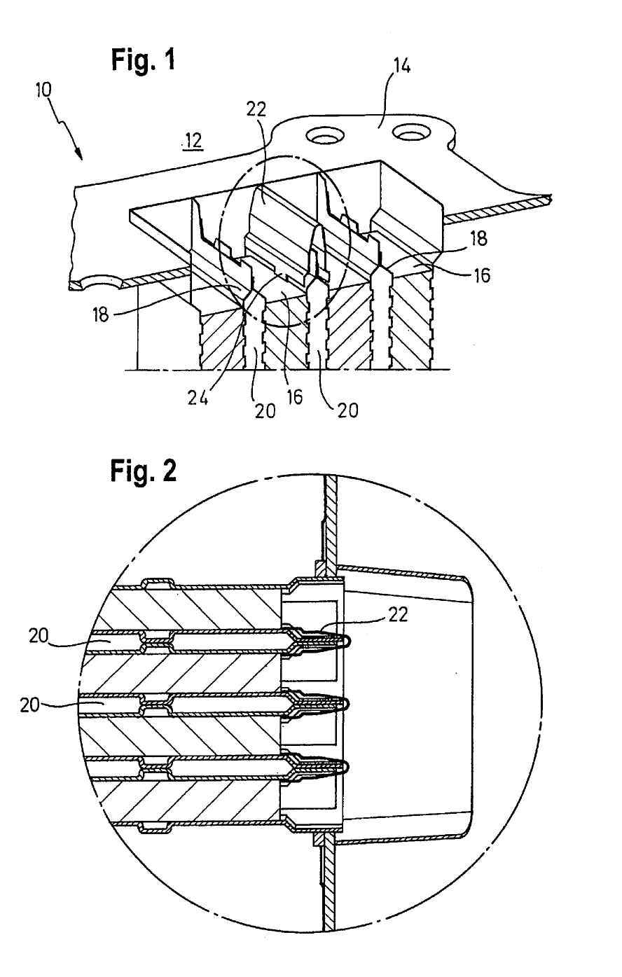

As can be seen in FIG. 1 the exhaust gas cooler 10 according to the invention is mountable in the depicted case via a flange provided at its inlet 12 and comprises in the direction of flow (in FIG. 1 downward) numerous exhaust gas channels or tubes 16, which, for better heat transfer, can be filled with ribs or fins. The exhaust gas tubes 16 conventionally have a constant cross section in the direction of flow and are defined by walls which, a few millimeters or centimeters from the inlet, in the case of initially adjacent walls, comprise stages 18 extending away from one another such that flow channels 20 for coolants are defined. The edges, located in FIG. 1 above, of the walls of the exhaust gas tubes 16 consequently point in the direction of flow and, due to the inflowing hot exhaust gas, become especially hot. To protect the described edges of the walls, caps 22 are provided according to the invention, of which in FIG. 1 only one cap is depicted. However, it is understood that further edges can preferably comprise such caps 22 or coverings. In FIG. 1 a securement tab 24 extending in the direction of flow from the cap 22 is evident of which on each on each side, in FIG. 1 left and right, two or more can be provided. In FIG. 1 is further evident that the cap 22 is implemented symmetrically with respect to a plane containing the direction of flow and the edge at the inlet.

This is supplementarily evident in FIG. 2. Here, again, the symmetry with respect to a plane can be seen which comprises in the direction of flow (in FIG. 2 from right to left) and the extent of the edge of the exhaust gas tube (in FIG. 2 perpendicular to the plane of the drawing). Further evident in FIG. 2 is the rounded front end, pointing in the direction of flow of the covering 22. Over approximately half of the course of the covering in the direction of flow, it is implemented with a minimal obliquity, meaning it is implemented at an acute angle with respect to the direction of flow. Adjacent thereto is a section largely parallel to the direction of flow. Succeeding thereto is implemented a stage 18 and by means of a further section implemented approximately parallel to the direction of flow, is carried out the attachment on those walls of two adjacent exhaust gas tubes that define between them flow channels 20 for liquid coolant. In the interior of cap 22 and toward the wall of the particular exhaust gas tube, an air gap is formed which ensures the described thermal insulation. With the possible exception of securement tabs, the cap, over its extent along the edge of the exhaust gas tube, which means in FIG. 2 perpendicularly to the plane of drawing, advantageously has a constant profile.

1.-9. (canceled)

10. An exhaust gas cooler with at least one exhaust gas channel defined by at least one wall which comprises at the inlet at least one edge substantially perpendicular to the direction of flow, wherein at least one edge is covered by a cap which defines an air gap toward the edge.

11. An exhaust gas cooler according to claim 10, wherein at least one cap has at least one maximal extent perpendicular to the direction of flow, which corresponds to a width of the wall perpendicular to the direction of flow and/or a distance between two exhaust gas channels perpendicular to the direction of flow.

12. An exhaust gas cooler according to claim 10, wherein at least one cap is plugged onto two adjacent walls of exhaust gas channels.

13. An exhaust gas cooler according to claim 10, wherein one end directed toward the direction of at least one cap is implemented to be rounded.

14. An exhaust gas cooler according to claim 10, wherein at least one cap in its course in the direction of flow comprises at least one obliquity and/or one stage.

15. An exhaust gas cooler according to claim 10, wherein at least one cap is implemented of a metal, in particular of sheet steel.

16. An exhaust gas cooler according to claim 10, wherein at least one cap comprises at least one securement tab.

17. An exhaust gas cooler according to claim 10, wherein at least one cap is soldered or welded onto two adjacent walls of exhaust gas channels.

18. An exhaust gas recirculation system with at least one exhaust gas cooler according to claim 10.

19. An exhaust gas cooler according to claim 11, wherein at least one cap is plugged onto two adjacent walls of exhaust gas channels.

20. An exhaust gas cooler according to claim 11, wherein one end directed toward the direction of at least one cap is implemented to be rounded.

21. An exhaust gas cooler according to claim 12, wherein one end directed toward the direction of at least one cap is implemented to be rounded.

22. An exhaust gas cooler according to claim 11, wherein at least one cap in its course in the direction of flow comprises at least one obliquity and/or one stage.

23. An exhaust gas cooler according to claim 12, wherein at least one cap in its course in the direction of flow comprises at least one obliquity and/or one stage.

24. An exhaust gas cooler according to claim 13, wherein at least one cap in its course in the direction of flow comprises at least one obliquity and/or one stage.

25. An exhaust gas cooler according to claim 11, wherein at least one cap is implemented of a metal, in particular of sheet steel.

26. An exhaust gas cooler according to claim 12, wherein at least one cap is implemented of a metal, in particular of sheet steel.

27. An exhaust gas cooler according to claim 13, wherein at least one cap is implemented of a metal, in particular of sheet steel.

28. An exhaust gas cooler according to claim 14, wherein at least one cap is implemented of a metal, in particular of sheet steel.

29. An exhaust gas cooler according to claim 11, wherein at least one cap comprises at least one securement tab.
